(19) United States
(12) Patent Application Publication
(10) Pub. No.: US 2024/0369995 A1
(43) Pub. Date: Nov. 7, 2024

(54) NUMERICAL CONTROLLER AND STORAGE MEDIUM

(71) Applicant: Fanuc Corporation, Minamitsuru-gun, Yamanashi (JP)

(72) Inventor: Yuu OOTA, Minamitsuru-gun, Yamanashi (JP)

(73) Assignee: Fanuc Corporation, Minamitsuru-gun, Yamanashi (JP)

(21) Appl. No.: 18/682,985

(22) PCT Filed: Aug. 24, 2021
(86) PCT No.: PCT/JP2021/031020

§ 371 Date: Feb. 12, 2024

(51) Int. Cl. G05B 19/416; G05B 19/18; G05B 19/4063

(52) U.S. Cl. CPC G05B 19/4166; G05B 19/182; G05B 19/4063; G05B 2219/30

(57) ABSTRACT

This numerical controller is for controlling a work machine having at least a first axis and a second axis. The numerical controller controls the synchronization of the first axis and the second axis of the machine tool; acquires a cutting start position for a tool of the machine tool; stores tool information relating to the tool; calculates a monitoring start position obtained by correcting the cutting start position on the basis of a tool shape stored in the tool information; and begins monitoring a synchronization error between the first axis and the second axis when the tool of the work machine reaches or approaches the monitoring start position.

### CROSS REFERENCE TO RELATED APPLICATIONS

This is the U. S. National Phase application of PCT/JP2021/031020, filed Aug. 24, 2021, the disclosure of this application being incorporated herein by reference in its entirety for all purposes.

### FIELD OF THE INVENTION

The present invention relates to a numerical controller and a storage medium.

### BACKGROUND OF THE INVENTION

Conventionally, there is a processing method for synchronizing a first axis with a second axis. For example, tapping is a method for forming a screw hole while synchronizing a main axis with a feed axis to keep a speed ratio constant between the main axis and the feed axis.

Patent Literature 1 discloses that “an amount of deviation error between a deviation of a feed axis and a deviation of main axis is detected, and when the amount is equal to or larger than a predefined value, it is determined that there is abnormality and output of a complementary signal is stopped, thereby reliably preventing damage of a tool, stripping of a thread or others caused by a deviation of synchronization between the main axis and the feed axis”.

When a screw hole is formed by using the method as presented in Patent Literature 1, (1) a hole is made by a drill, then (2) the drill is changed to a tap, (3) the tap is moved rapidly to an R-point to (4) cut a thread on the inner surface of the hole, and (5) the tap is pulled out by rotating it backward.

As described above, to keep the thread pitch constant in the formation of the thread, synchronization of the rotational speed and the feed speed in the main axis is required. Conventionally, in tapping, there are cases where the main axis stops at the R-point for synchronization and the main axis does not stop at the R-point. When the axis is stopped for synchronization, synchronization accuracy can be secured, but it takes time to stop and restart the move of the main axis. Cycle time can be reduced if synchronization control can be started without stopping the axis at the R-point.

### PATENT LITERATURE

[Patent Literature 1] Japanese Patent Laid-Open Publication No. H6-304814 (304814/1994)

### SUMMARY OF THE INVENTION

However, in the case where the axis is not stopped at the R-point and monitoring of the synchronization is started at the R-point, amount of error occurs in the operation right before the R-point may be mistakenly recognized as synchronization error the move of the axis right before reaching the R-point. Large tolerance prevents such misrecognition but error detection accuracy is decreased during the formation of the screw hole.

In the field of machining, there is a demand of a technology to reduce the cycle time while securing the accuracy of multi-axis control.

An aspect of the present invention is a numerical controller that is for controlling a machine tool having at least a first axis and a second axis, comprising: a synchronization control unit that controls synchronization between the first axis and the second axis; a cutting start position acquisition unit that acquires a cutting start position of a tool of the machine tool; a tool information storage unit that stores tool information that is about the tool of the machine tool; a monitoring t position correction unit that calculates a monitoring start position which is the cutting start position corrected based on a shape of the tool included in the tool information; and a synchronization error monitoring unit start monitoring a synchronization error at the monitoring start position or its vicinity of the tool of the machine tool.

An aspect of the present invention is a storage medium that is for storing a computer-readable command that is executed by one or more processors to perform: controlling a first axis and a second axis of a machine tool; acquiring a cutting start position of a tool of the machine tool; storing tool information that is about the tool; calculating a monitoring start position which is the cutting start position corrected based on a shape of the tool included in the tool information; and starting monitoring a synchronization error between the first axis and the second axis when the tool of the machine tool reaches or approaches the monitoring start position.

One aspect of the invention can reduce the cycle time while securing the accuracy of the multi-axis control.

### BRIEF DESCRIPTION OF THE DRAWINGS

FIG. 1 is a hardware configuration diagram of a numerical controller;

FIG. 2 is a block diagram of the numerical controller according to a first disclosure;

FIG. 3 is a flowchart illustrating synchronization control according to the first disclosure;

FIG. 4 is a diagram illustrating rigid tapping;

FIG. 5 is a block diagram of the numerical controller according to a second disclosure;

FIG. 6 shows an example of a processing program;

FIG. 7 is a diagram showing changes in a load torque during cutting a prepared hole by a drill;

FIG. 8 shows an example of tool information;

FIG. 9 is a diagram showing a relationship between an R-point, a cutting start position and a monitoring start position for a synchronization error;

FIG. 10 is a diagram showing changes in a synchronization error in a conventional numerical controller;

FIG. 11 is a diagram showing a relationship between the synchronization error and a threshold value in the convention numerical controller;

FIG. 12 is a diagram showing changes in a synchronization error in the numerical controller of the disclosure;

FIG. 13 is a diagram showing a relationship between the synchronization error and a threshold value in the numerical controller of the disclosure;

FIG. 14 shows an example of drill tapping;

FIG. 15 is a diagram illustrating an operation of the drill tapping; and

FIG. 16 shows an example of a processing program.

With reference to FIG. 1, a description will be made about a hardware configuration of a numerical controller 100 for controlling a machine tool 200. The numerical controller 100 includes a central processing unit (CPU) 111 that is a processor for controlling the entire numerical controller 100. The CPU 111 is configured to read a system program from a read-only memory (ROM) 112 through a bus thereby control the entire numerical controller 100 in accordance with the system program. A random-access memory (RAM) 113 is configured to temporarily store temporary computation data and pieces of data to be displayed, as well as various data input by a user through an input unit 71.

A display unit 70 is a monitor or similar that is attached to the numerical controller 100. The display unit 70 is configured to display such as an operation screen and a setting screen of the numerical controller 100.

The input unit 71 is a keyboard, touch panel or similar that is integral with or separate from the display unit 70. The user operates the input unit 71 to input data to a screen, for instance. The display unit 70 and the input unit 71 may be handheld devices.

A non-volatile memory 114 is, for instance, a memory that is backed up by a battery, not shown, so that a state of storage is retained even when a power source of the numerical controller 100 is turned off. The non-volatile memory 114 is configured to store programs read from an external device via an interface, not shown, programs input through the input device 71, and various data acquired from the units of the numerical controller 100, the machine tool 200 and others (e.g., setting parameters acquired from the machine tool 200). The programs and the various data stored in the non-volatile memory 114 may be deployed into the RAM 113 when they are executed/used. Furthermore, the ROM 112 is configured to store various system programs in advance.

A controller 40 that controls the machine tool 200 is configured to convert an axis moving command from the CPU 111 into a pulse signal, and output the pulse signal to a driver 41. The driver 41 is configured to convert the pulse signal into a current to drive a servomotor of the machine tool 200. The servomotor is configured to move the tools under the control by the numerical controller 100. In the present disclosure, the machine tool 200 has at least two axes for rotation and feeding.

### First Disclosure

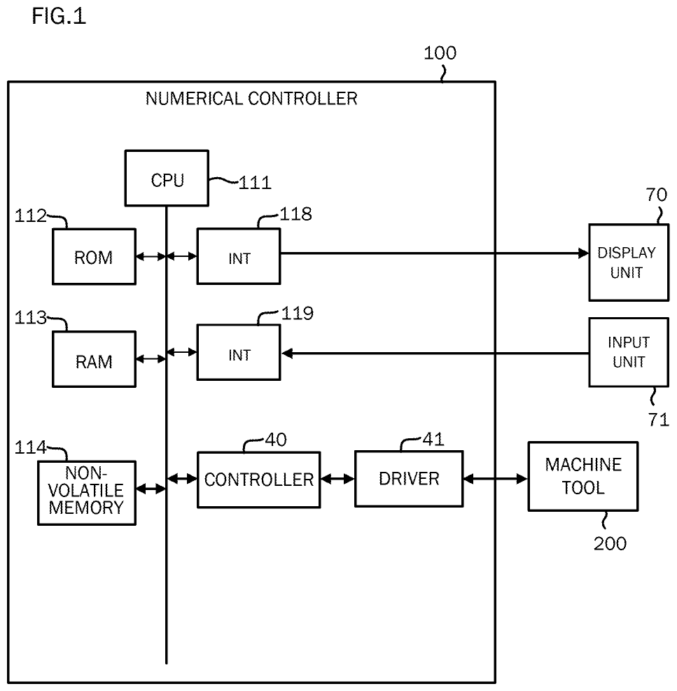

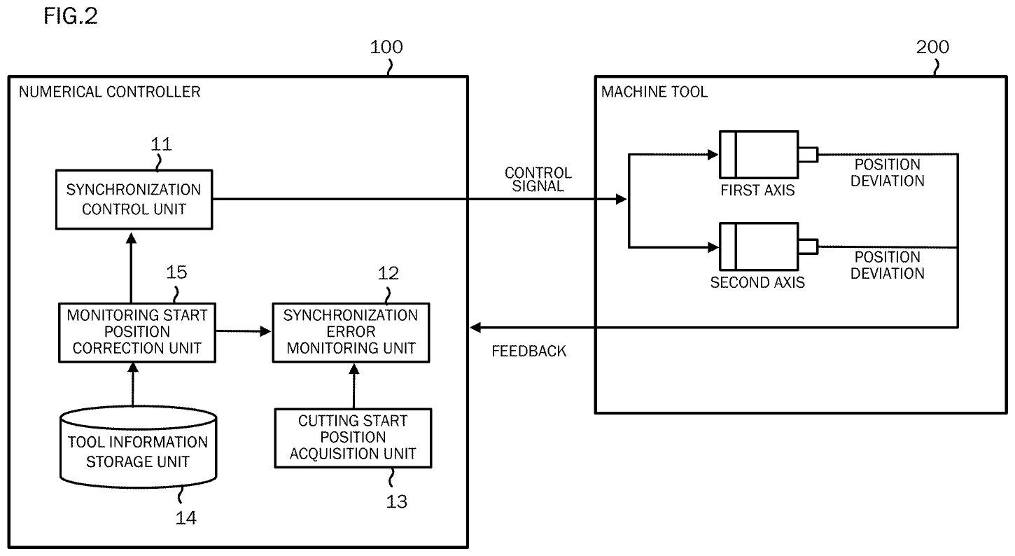

FIG. 2 is a block diagram of the numerical controller 100 according to a first disclosure. The numerical controller 100 conducts synchronization control of a plurality of axes. The machine tool 200 controls a first axis and a second axis and keeps the synchronization of these axes while cutting.

The numerical controller 100 includes a synchronization control unit 11 that conducts the synchronization control of the axes, a synchronization error monitoring unit 12 that monitors a synchronization error between the axes, a cutting start position acquisition unit 13 that acquires cutting start positions of a tool and a workpiece, a tool information storage unit 14 that stores tool information, such as a shape of a tool, and a monitoring start position correction unit 15 that corrects the cutting start positions based on the tool information.

The synchronization control unit 11 is configured to control the synchronization between the axes of the machine tool 200 according to synchronization conditions. The synchronization control unit 11 multiplies an amount of movement of the first axis by a synchronization ratio which is defined in the synchronization conditions to calculate an amount of movement of the second axis for each control cycle. Then, based on the amount of the first axis movement and the calculated amount of the second axis movement, a servomotor controls the first axis and the second axis.

The synchronization error monitoring unit 12 is configured to store a preset threshold value. A position deviation of the first axis and a position deviation of the second axis are input to the synchronization error monitoring unit 12. The position deviation means a difference between a position indicated by a command and an actual position. The synchronization error monitoring unit 12 calculates a synchronization error based on these position deviations. The synchronization error monitoring unit 12 compares the synchronization error with the threshold value, and when the synchronization error exceeds the threshold value, determines that the synchronization error occurred. As will be described later in the illustrative disclosure, the monitoring of the synchronization error is started at a monitoring start position or the vicinity of the position.

The cutting start position acquisition unit 13 is configured to acquire a position of the tool when the cutting of the workpiece is started. The position specifies location or time.

The cutting start position may be acquired by detecting the position based on a load torque or by estimating the position based on a drawing or others.

When the cutting start position is estimated based on the load torque, changes in the load torque is monitored and a position where the load torque rose up is determined where the tool starts the cutting of the workpiece. In a case where cutting is applied to the same face several times, the earlier rising edge of a load torque is determined as the cutting start position.

When the cutting start position is estimated based on the drawing or others, an estimation result may be input as a parameter to the numerical controller 100 by an operator or may be written into a processing program, by way of example.

The monitoring start position correction unit 15 is configured to determine the position where the monitoring of the synchronization error is started based on the tool information and the cutting start position. The tool information includes the shape of the tool. The monitoring start position correction unit 15 corrects a deviation of the cutting start position that is caused by the shape of the tool. A position corrected based on the tool information is called the monitoring start position.

The synchronization control unit 11 starts the synchronization control when the tool reaches an R-point. The synchronization error monitoring unit 12 starts monitoring the synchronization error when the tool reaches the monitoring start position or its vicinity. To make the synchronization error sufficiently small, synchronization control is started after the R-point and before the monitoring start position. That allows smaller threshold can be set because the synchronization error is controlled to sufficiently small before the of monitoring the synchronization error is started. Smaller threshold value improves the accuracy of the synchronization.

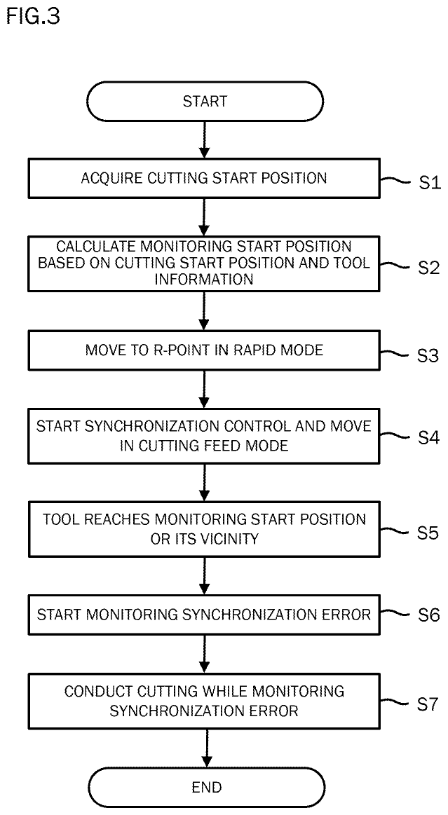

The synchronization control in the first disclosure will now be described by referring to a flowchart in FIG. 3.

The numerical controller 100 acquires the cutting start position (Step S1). The cutting start position can be acquired from the information, such as the load torque of the tool and the drawings.

The numerical controller 100 corrects the deviation of the cutting start position due to the shape of the tool and calculates the monitoring start position based on the cutting start position and the tool information (Step S2).

The numerical controller 100 reads the processing program to move the tool of the machine tool 200 to a position written in the processing program. The numerical controller 100 moves the tool in a rapid feed mode to the R-point (Step S3), and then moves the tool at a cutting feed mode after passing the R-point. When the tool passes the R-point, the numerical controller 100 starts the synchronization control of the first axis and the second axis (Step S4).

When the tool reaches the monitoring start position or its vicinity (Step S5), the numerical controller 100 starts monitoring the synchronization error (Step S6). The numerical controller 100 conducts the cutting while monitoring the synchronization error (Step S7).

As described above, the numerical controller 100 of the first disclosure is configured to conduct the cutting while maintaining the synchronization at least between the first axis and the second axis. The numerical controller 100 also calculates the monitoring start position by correcting the cutting start position according to the shape of the tool and starts monitoring the synchronization error from the monitoring start position.

The synchronization error is large at the R-point where a moving mode changes from rapid feed mode to cutting feed mode, and then gradually converges after passing the R-point. The monitoring of the synchronization deviation from the R-point to the start of cutting is required because the deviation between the range does not affect the cutting accuracy.

The numerical controller 100 of the illustrative disclosure starts monitoring the synchronization error at the monitoring start position where the cutting is started. The threshold value for the synchronization error can be set to an appropriate value and valid synchronization control can be performed because the unnecessary synchronization deviation is not detected. In addition to that, shift to the cutting feed mode is performed without stopping at the R-point, thereby a cycle time can be reduced.

### Second Disclosure

The numerical controller 100 according to a second disclosure will be described with an example of rigid tapping.

The rigid tapping comprises steps for forming a prepared hole by a drill, and forming a thread on the inner surface of the prepared hole.

FIG. 4 shows an example of a rigid tap in which (1) a rigid tap is moved in the rapid feed mode from an I-point (starting point) to the R-point, and (2) the moving mode is changed into cutting feed mode at the R-point. During the cutting feed mode, the synchronization control of the feed of a Z-axis and the rotation of the main axis is conducted. The synchronization is maintained during the formation of the thread on the inner surface of the prepared hole. When the cutting is completed, the rigid tap is (3) returned to the R-point while rotating in reverse, and (4) moved in the rapid feed mode after passing the R-point.

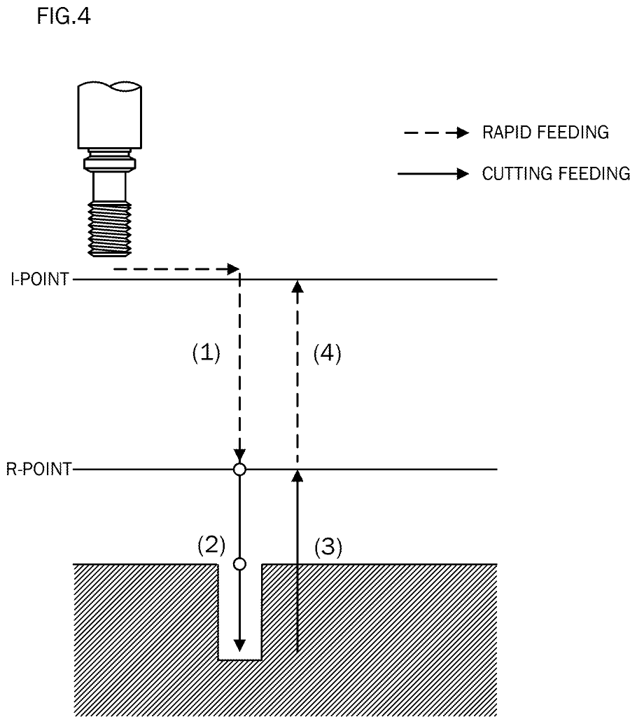

FIG. 5 is a block diagram of the numerical controller 100 of the second disclosure.

The numerical controller 100 of the second disclosure includes a synchronization control unit 11 that conducts the synchronization control on axes, a synchronization error monitoring unit 12 that monitors a synchronization error between the axes, a cutting start position acquisition unit 13 that acquires cutting start positions of a tool and a workpiece, a tool information storage unit 14 that stores tool information, such as a shape of a tool, a monitoring start position correction unit 15 that corrects the cutting start positions based on the tool information, and a tool determination unit 16 that determines a tool to be used for cutting.

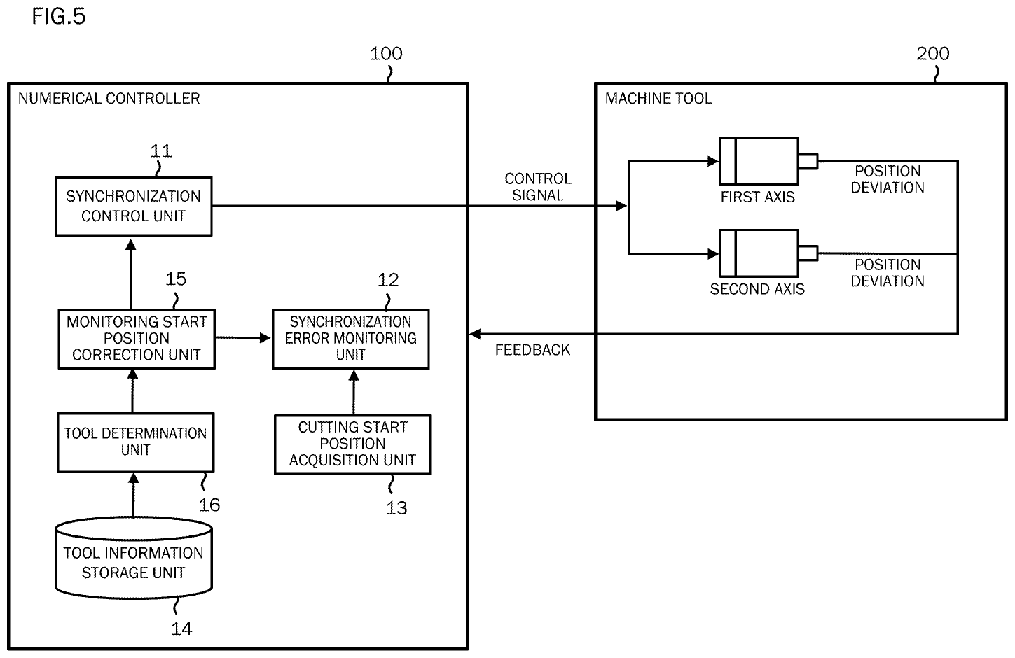

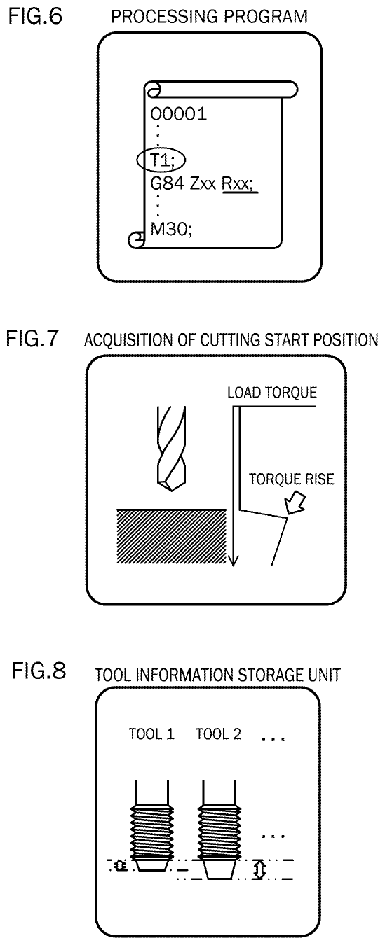

The synchronization control unit 11 is configured to control synchronization between a first axis and a second axis of a machine tool according to a processing program. In the second disclosure, the first axis and the second axis are a main axis and a Z-axis, respectively. FIG. 6 shows an example of the processing program. In the figure, “G84 Zxx Rxx;” is a command for tapping. The term “Zxx” is a distance from the R-point to the bottom of the hole, and the term “Rxx” is a distance from the initial level to the R-point. The synchronization control unit starts 11 the synchronization control when a tool reaches the R-point.

The cutting start position acquisition unit 13 is configured to detect a position of a surface of a workpiece based on a load torque of the drill during forming the prepared hole. FIG. 7 shows a change in the load torque during forming the prepared hole. When the drill is moved toward the workpiece and the tip of the drill comes into contact with the workpiece, the load torque rises up. The cutting start position acquisition unit 13 monitors a load torque of the main axis and detects the cutting start position of the tool.

The tool information storage unit 14 is configured to store shapes of various types of tools. In FIG. 8, the shapes of two rigid taps are stored. In the tool information, for example, the length of a biting section of the rigid tap is written. The lengths of the biting sections of the rigid taps in FIG. 8 are different from each other.

The tool determination unit 16 is configured to analyze the processing program to determine a tool to be used for processing. According to the processing program shown in FIG. 6, the tool determination unit 16 determines about which tool is to be used based on a code “T1” for performing tool selection. In the second disclosure, the code “T1” indicates the types of the rigid taps.

The monitoring start position correction unit 15 is configured to read the tool information determined by the tool determination unit 16 and correct a deviation of the cutting start position due to the shape of the tool. In the tool information, a method for correcting the cutting start position for each tool is written. The monitoring start position correction unit 15 refers to the tool information to calculate a monitoring start position. In this case, monitoring start position is a position advanced by the length of the biting section from the cutting start position.

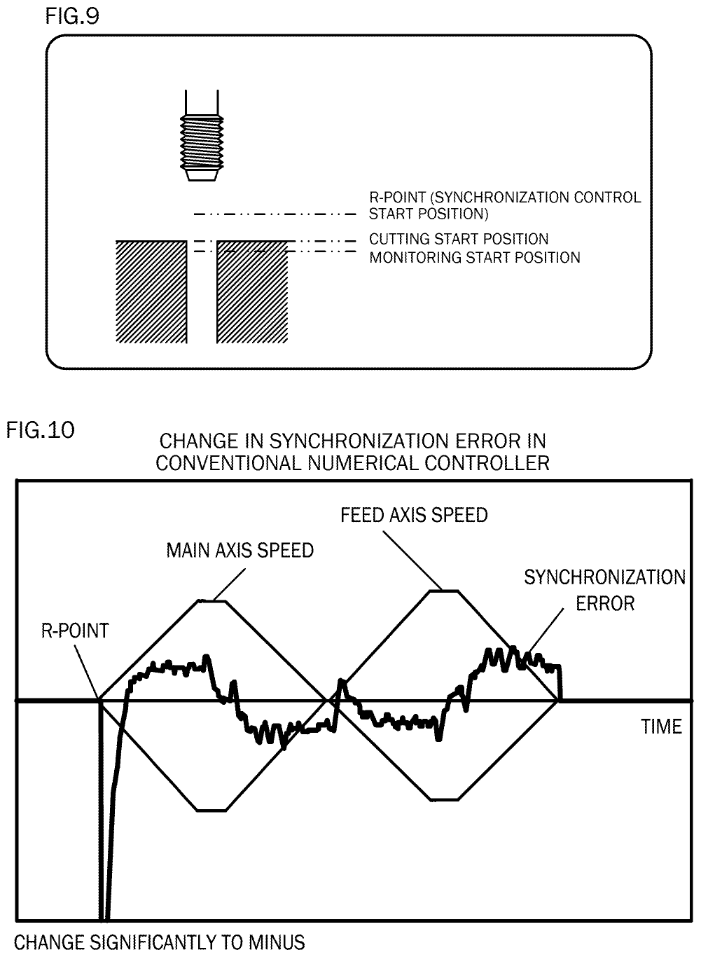

FIG. 9 shows a relationship between the R-point, the cutting start position, and the monitoring start position for the synchronization error. The cutting start position is a position at which the drill starts the cutting to form the prepared hole. The rigid tap has the biting section at its tip. The monitoring start position for the synchronization error is advanced by the length of the biting section of the rigid tap. A corrected cutting start position corresponds to the monitoring start position for the synchronization error.

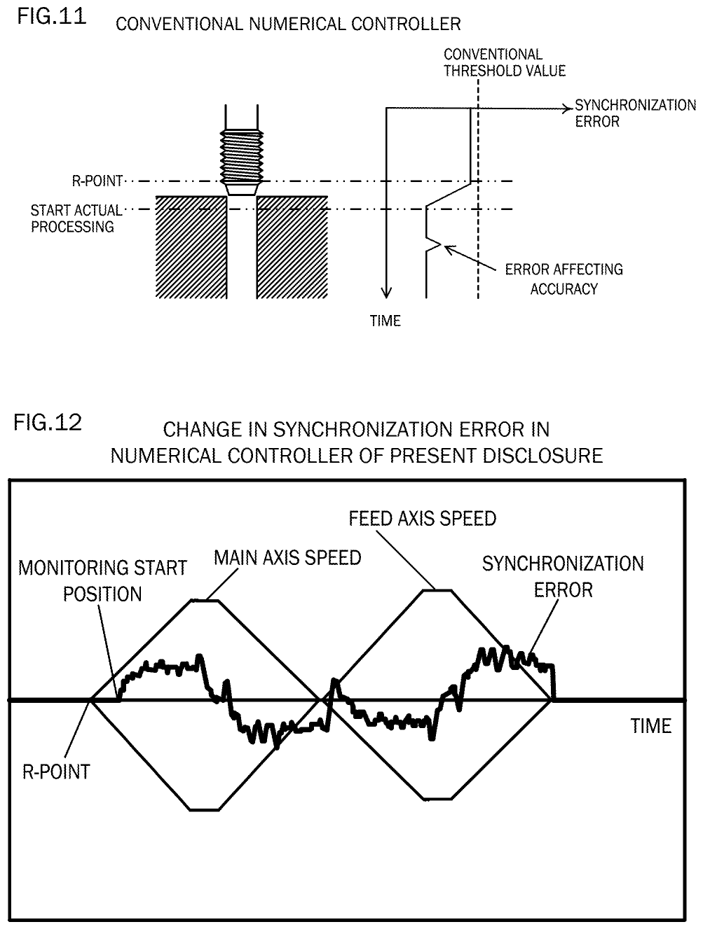

A description will now be made about a relationship between a change in a synchronization error in a conventional numerical controller and a threshold value by referring to FIGS. 10 and 11.

FIG. 10 shows the change in the synchronization error in the conventional numerical controller. The synchronization error changes significantly to minus at the R-point, and converges near zero by the time the cutting is started.

The conventional numerical controller sets the threshold value for the synchronization error (acceptable error) sufficiently large so that the large synchronization error monitored after R-point not to be determined as an error (see FIG. 11). However, a large threshold value may lead misdetection that affects accuracy during cutting.

FIG. 12 shows a change in a synchronization error in the numerical controller 100 of the illustrative disclosure. On the graph, the synchronization error from the R-point to the monitoring start position is zero, because the numerical controller 100 does not monitor the synchronization error. At the monitoring start position, the synchronization error converges sufficiently.

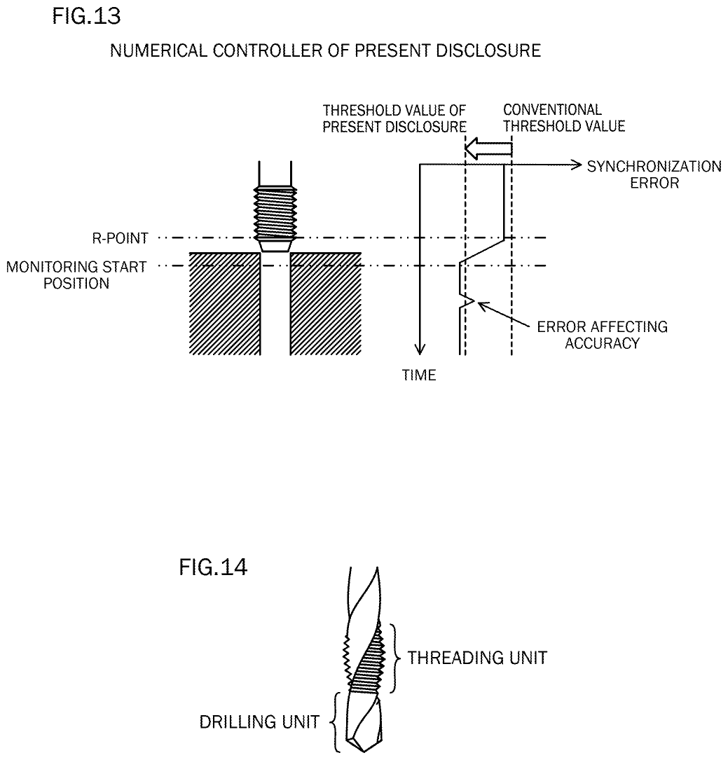

In the illustrative disclosure, setting a large threshold value is not required because the numerical controller 100 of the illustrative disclosure starts monitoring the synchronization error at the monitoring start position at which the synchronization error converges sufficiently (see FIG. 13). Thus, setting an appropriate threshold value can improve the accuracy of determining the synchronization error.

According to the numerical controller 100 of the illustrative disclosure, appropriate threshold value can be set because monitoring to detect the synchronization error starts at the position of starting cutting or the vicinity of this position. Furthermore, a moving mode of the tool can be changed to a cutting feed mode at the R-point without stopping the tool, so that the cycle time can be reduced.

The numerical controller 100 of the second disclosure includes the tool determination unit 16. The numerical controller 100 determines a tool to be used based on the processing program and the like, and then reads out the tool information. In the tool information, a program that corrects a monitoring start position for each tool is written. The numerical controller 100 automatically determines a tool to be used for cutting even if there are multiple tools to be used, thereby enabling the correction of the monitoring start position according to the shape of the tool.

### Third Disclosure

The numerical controller 100 according to a third disclosure will be described by taking a drill tap for example.

The drill tap is for forming a hole and a thread simultaneously. FIG. 14 shows an example of the drill tap. The drill tap has its tip provided with a drilling unit, and further with a threading unit.

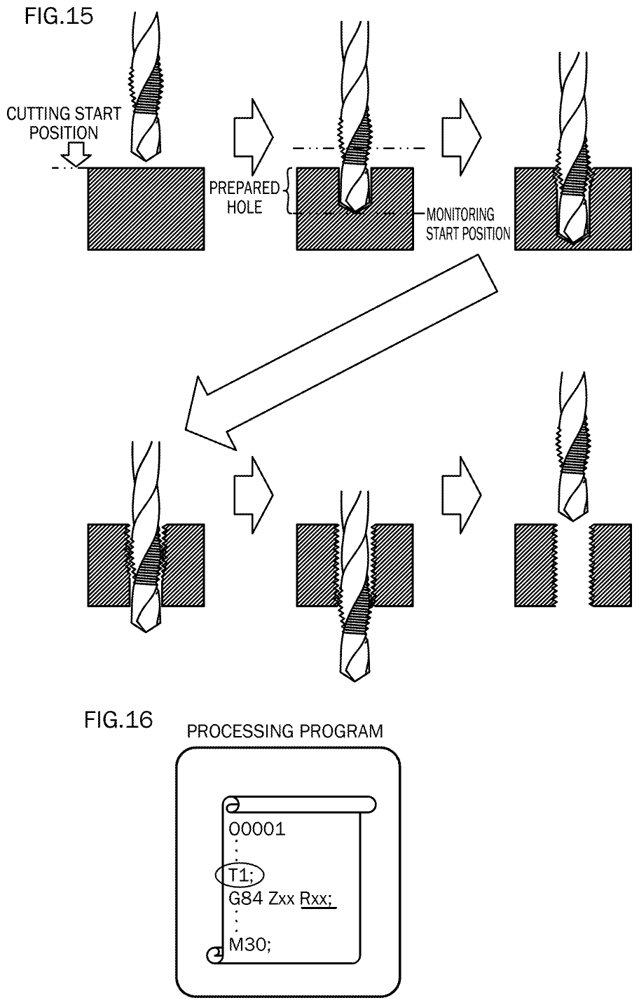

The length of the drilling unit of the drill tap in the third disclosure corresponds to the length of the biting unit of the rigid tap in the second disclosure. The drill tap starts synchronization control at an R-point, and as shown in FIG. 15, starts cutting when the tip of the drilling unit comes into contact with a workpiece. The numerical controller 100 can detect from a load torque that the tip of the drilling unit comes into contact with the workpiece. This position is defined as a cutting start position.

When a main axis is moved downward along a Z-axis while rotating, the drilling unit forms a prepared hole. The threading unit in turn forms a thread on the inner surface of the prepared hole. The position of the tip of the tool when the threading is started corresponds to a monitoring start position. The drill tap is moved upward while rotating in reverse after the thread is formed to a predefined position.

The numerical controller 100 of the third disclosure has the same configuration as that of the numerical controller 100 of the second disclosure. The matters different from those in the numerical controller 100 of the second disclosure will be described below.

The synchronization control unit 11 is configured to control synchronization between a first axis and a second axis of a machine tool 200. In the third disclosure, the first axis and the second axis correspond to a main axis and a Z-axis, respectively. In FIG. 16, “G84 Zxx Rxx;” is a command for tapping. The term “Zxx” is a distance from the R-point to the bottom of the hole, and the term “Rxx” is a distance from the initial level to the R-point. The synchronization control unit 11 starts the synchronization control when a tool reaches the R-point.

The tool determination unit 16 is configured to analyze the processing program to determine the type of a tool to be used for processing. FIG. 16 shows an example of the processing program. The tool determination unit 16 determines about the type of the tool based on a code “T1” for tool selection. In the third disclosure, the code “T1” indicates a drill tap.

The tool information storage unit 14 is configured to store a method for acquiring the cutting start position for each tool and a method for calculating the monitoring start position, for instance.

The cutting start position acquisition unit 13 is configured to acquire a cutting start position through a method corresponding to the shape and type of the tool according to the tool information. As of the drill tap, a position where the tip of the drill tap comes into contact with a workpiece is the cutting start position.

The monitoring start position correction unit 15 is configured to correct the cutting start position based on the shape of the tool and define a monitoring start position for the synchronization error. The monitoring start position is a position advanced by the length of the drilling section from the cutting start position. The monitoring start position correction unit 15 calculates the monitoring start position for the synchronization error by adding the length of the drilling section to the cutting start position.

The numerical controller 100 of the third disclosure reads the tool information on the drill tap and determines the monitoring start position for the synchronization error. According to the second disclosure and the third disclosure, the cutting start position and the monitoring start position can be acquired according to the tool information after the tool to be used for processing is determined.

REFERENCE SIGNS LIST
100 Numerical Controller
11 Synchronization Control Unit
12 Synchronization Error Monitoring Unit
13 Cutting Start Position Acquisition Unit
14 Tool Information Storage Unit
15 Monitoring Start Position Correction Unit
16 Tool Determination Unit
111 CPU
112 ROM
113 RAM
114 Non-Volatile Memory

1. A numerical controller for controlling a machine tool having at least a first axis and a second axis, comprising:
a synchronization control unit that controls synchronization between the first axis and the second axis;
a cutting start position acquisition unit that acquires a cutting start position of a tool of the machine tool;
a tool information storage unit that stores tool information that is about the tool of the machine tool;
a monitoring start position correction unit that calculates a monitoring start position which is the cutting start position corrected based on a shape of the tool included in the tool information; and
a synchronization error monitoring unit start monitoring a synchronization error at the monitoring start position or its vicinity of the tool of the machine tool.

2. The numerical controller according to claim 1, comprising a tool determination unit that determines a tool to be used for cutting, wherein
the tool information storage unit stores tool information about at least two tools, and
the monitoring start position correction unit reads tool information determined by the tool determination unit from the tool information storage unit and calculate the monitoring start position.

3. The numerical controller according to claim 1, wherein the tool information includes an acquisition method for acquiring a cutting start position, and
the cutting start position acquisition unit acquires the cutting start position according to the acquisition method.

4. The numerical controller according to claim 1, wherein the first axis is a main axis and the second axis is a feed axis in an axis direction of the main axis,
the synchronization control unit controls synchronization between a rotation of the main axis and a speed of the feed axis,
the tool is a tap, and
the monitoring start position correction unit calculates the monitoring start position which is the cutting start position corrected based on a length between a tip of the tap and a portion for forming a thread.

5. A storage medium for storing a computer-readable command that is executed by one or more processors to perform:
controlling a first axis and a second axis of a machine tool;
acquiring a cutting start position of a tool of the machine tool;
storing tool information that is about the tool;
calculating a monitoring start position which is the cutting start position corrected based on a shape of the tool included in the tool information; and
starting monitoring a synchronization error between the first axis and the second axis when the tool of the machine tool reaches or approaches the monitoring start position.
